(19) United States
(12) Patent Application Publication
(10) Pub. No.: US 2025/0065320 A1
(43) Pub. Date: Feb. 27, 2025

(54) FULL RECOVERY PROCESSES FOR CARBON DIOXIDE DISCHARGED FROM CATALYTIC CRACKING REGENERATION DEVICES

(71) Applicant: SHANGHAI YUANHAN ENERGY & CHEMICAL TECHNOLOGY CO., LTD., Shanghai (CN)

(72) Inventors: Yunfeng ZHANG, Shanghai (CN); Qing LIU, Shanghai (CN); Xiangquan ZHANG, Shanghai (CN); Wenjun WU, Shanghai (CN)

(73) Assignee: SHANGHAI YUANHAN ENERGY & CHEMICAL TECHNOLOGY CO., LTD., Shanghai (CN)

(21) Appl. No.: 18/939,471

(22) Filed: Nov. 6, 2024

Related U.S. Application Data
(63) Continuation-in-part of application No. 18/421,962, filed on Jan. 24, 2024.
Application No. 18/421,962 is a continuation-in-part of application No. PCT/CN2022/086411, filed on Apr. 12, 2022.

(30) Foreign Application Priority Data
Aug. 3, 2021 (CN) 202110884249.3

(51) Int. Cl. B01J 38/02; C10G 11/18

(52) U.S. Cl. CPC B01J 38/02; C10G 11/182; C10G 2300/708

(57) ABSTRACT

The embodiments of the present disclosure provide a full recovery process for carbon dioxide emitted from a catalytic cracking regeneration device, which is executed by a processor of a full recovery system for carbon dioxide. The full recovery process includes recovering, through a flue gas recovery device, a circulated flue gas generated by the catalytic cracking regeneration device, and mixing the circulated flue gas and oxygen to produce a carbon-based gas; determining a concentration sequence and a gas flow rate sequence in a connection pipe, and a reaction parameter of the catalytic cracking regeneration device; determining a combustion feature based on the concentration sequence and the gas flow rate sequence; and in response to the combustion feature satisfying a first preset condition, determining a target opening combination of a target flow rate regulating valve based on at least the combustion feature and the reaction parameter.

This application is a continuation-in-part of U.S. patent application Ser. No. 18/421,962, filed on Jan. 24, 2024, which is a continuation-in-part of International Patent Application No. PCT/CN2022/086411, filed on Apr. 12, 2022, which claims priority to Chinese Patent Application No. 202110884249.3, filed on Aug. 3, 2021, the entire contents of each of which are hereby incorporated by reference.

### TECHNICAL FIELD

The present disclosure relates to the field of catalytic cracking regeneration technology, and in particular, to a full recovery process for carbon dioxide discharged from a catalytic cracking regeneration device.

### BACKGROUND

With the gradual development of the industry, the use of catalytic cracking reaction devices has become increasingly frequent. The catalytic cracking reaction device usually catalyzes the reaction process through an internal catalyst. However, side reactions often occur in the catalytic cracking process, which produce pollutants, such as coke, that are deposited on the catalyst, reducing the activity of the catalyst and leading to a reduction in the catalytic efficiency of the reaction.

When contaminant deposition occurs, the catalytic cracking reaction device can be regenerated by feeding air into the catalytic cracking reaction device for combustion to remove contaminants such as coke. CN118577060A discloses a catalyst regeneration device which introduces a catalyst into a regenerator provided with a cyclone separator for charring reaction with the air, and absorbs excessive heat generated during a regeneration process of the catalyst utilizing a heat collector. Existing catalytic cracking regeneration devices, however, tend to have low regeneration efficiencies and lack subsequent treatment of the discharged gases, making a large amount of fuel consumed and a large amount of pollutant gases discharged, which damages the environment.

Therefore, it is desirable to provide a novel full recovery process for carbon dioxide discharged from a catalytic cracking regeneration device to improve the regeneration efficiency, reduce energy consumption, and recycle the discharged gases to protect the environment.

### SUMMARY

One or more embodiments of the present disclosure provide a full recovery process for carbon dioxide discharged from a catalytic cracking regeneration device. The process may be implemented based on a processor of a full recovery system for carbon dioxide. The full recovery system for carbon dioxide may include the catalytic cracking regeneration device, a flue gas recovery device, a flue gas fan, an oxygen production device, and a carbon-based gas mixer. The carbon-based gas mixer may include an oxygen channel, an oxygen channel regulating valve, a flue gas recirculation channel, an oxygen distributor, a mixer, a carbon-based gas channel, and an oxygen concentration analyzer. The oxygen distributor may be a hollow cylinder. A plurality of small holes may be evenly provided on a peripheral wall of the hollow cylinder. The oxygen channel regulating valve may be located on the oxygen channel. An outlet of the oxygen channel may be connected with an end of the oxygen distributor. The oxygen distributor and a part of the oxygen channel may be inserted into the mixer through a side wall of the mixer. An outlet of the flue gas recirculation channel may be connected with one end of the mixer. An inlet of the carbon-based gas channel may be connected with another end of the mixer. The oxygen concentration analyzer may be provided on the carbon-based gas channel. The catalytic cracking regeneration device may be configured as a position of combustion and include a flue gas outlet, a temperature sensor, and a pressure sensor. The flue gas recovery device may be configured to process circulated flue gas, and include a waste heat boiler, a dust removal device, and a desulfurization device. The dust removal device may be connected with the waste heat boiler through an inlet pipe, and connected with the desulfurization device through an outlet pipe. The flue gas outlet of the catalytic cracking regeneration device may be connected with the flue gas recovery device through a first connection pipeline. The flue gas recovery device may be connected with the flue gas fan through a second connection pipeline. A venting pipe may be provided on the second connection pipe. The flue gas fan may be connected with the carbon-based gas mixer through a third connection pipeline. A first flow rate regulating valve may be provided on the third connection pipe. An oxygen outlet of the oxygen production device may be connected with the carbon-based gas mixer through a fourth connection pipeline. A second flow rate regulating valve may be provided on the fourth connection pipe between oxygen outlet of the oxygen production device and the carbon-based gas mixer. The carbon-based gas mixer may be connected with a bottom portion and an upper portion of the catalytic cracking regeneration device through a fifth connection pipeline, respectively. The fifth connection pipeline may include a main pipe and a branch pipe. The main pipe may be provided with a flow meter, a first temperature sensor, and a first pressure sensor. The branch pipe may be provided with a third flow rate regulating valve. A nitrogen outlet of the oxygen production device may be connected to the main pipe. An air combustion fan may be connected to the main pipe.

One or more embodiments of the present disclosure provide a full recovery process for carbon dioxide discharged from a catalytic cracking regeneration device, and the process may include following operations. 1) Air for combustion may be utilized at an initial stage, in response to generating a flue gas, a carbon-based gas made by mixing the circulated flue gas and oxygen may be utilized as a combustion agent to gradually replace the air for combustion, and after a period of circulation, the air may be completely replaced by the carbon-based gas for combustion, and the carbon-based gas for combustion may be in a normal operation. 2) In response to determining that the circulated flue gas enters the flue gas recovery device from the catalytic cracking regeneration device, the flue gas recovery device may be controlled to perform heat recovery, dedusting, and desulfurization on the circulated flue gas. The flue gas fan may be controlled to pressurize the circulated flue gas, part of a pressurized circulated flue gas may be introduced into the carbon-based gas mixer via the third connection pipe. The oxygen production device may be controlled to introduce the oxygen into the carbon-based gas mixer, and the oxygen and the circulated flue gas may be mixed in the carbon-based gas mixer to produce the carbon-based gas. 3) The carbon-based gas mixer may be controlled to introduce the carbon-based gas into the bottom portion and the upper portion of the catalytic cracking regeneration device in two ways. The carbon-based gas entering into the bottom portion of the catalytic cracking regeneration device may be a main combustion agent providing a majority of a combustion gas for combustion of a catalyst carbon deposit in the catalytic cracking regeneration device, and the carbon-based gas entering into the upper portion of the catalytic cracking regeneration device may be an auxiliary combustion agent providing the combustion gas for a small count of carbon monoxide that is not burned up in the catalytic cracking regeneration device. 4) The catalytic cracking regeneration device may be controlled to feed a generated circulated flue gas to the flue gas recovery device via the first connection pipe, operation 2) and operation 3) may be performed again.

### BRIEF DESCRIPTION OF THE DRAWINGS

The present disclosure will be further illustrated by way of exemplary embodiments, which will be described in detail with the accompanying drawings. These embodiments are non-limiting. In these embodiments, the same count indicates the same structure, wherein:

FIG. 1 is a schematic diagram illustrating a structure of a full recovery system for carbon dioxide according to some embodiments of the present disclosure;

FIG. 2 is a schematic diagram illustrating a structure of a carbon-based gas mixer according to some embodiments of the present disclosure;

FIG. 3 is a schematic diagram illustrating an exemplary arrangement of small holes on an oxygen distributor in a carbon-based gas mixer according to some embodiments of the present disclosure;

FIG. 4 is a schematic diagram illustrating an exemplary work process of a carbon-based gas mixer according to some embodiments of the present disclosure;

FIG. 5 is a flowchart illustrating an exemplary process of determining an opening combination of a flow rate regulating valve according to some embodiments of the present disclosure;

FIG. 6 is a schematic diagram illustrating an exemplary prediction model according to some embodiments of the present disclosure;

FIG. 7 is a schematic diagram illustrating a process of determining a target size according to some embodiments of the present disclosure; and

FIG. 8 is a schematic diagram illustrating an exemplary catalytic cracking regeneration device according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system”, “device”, “unit” and/or “module” as used herein is a manner used to distinguish different components, elements, parts, sections, or assemblies at different levels. However, if other words serve the same purpose, the words may be replaced by other expressions.

As shown in the present disclosure and claims, the words “one”, “a”, “a kind” and/or “the” are not especially singular but may include the plural unless the context expressly suggests otherwise. In general, the terms “comprise,” “comprises,” “comprising,” “include,” “includes,” and/or “including,” merely prompt to include operations and elements that have been clearly identified, and these operations and elements do not constitute an exclusive listing. The methods or devices may also include other operations or elements.

The flowcharts used in the present disclosure illustrate operations that systems implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

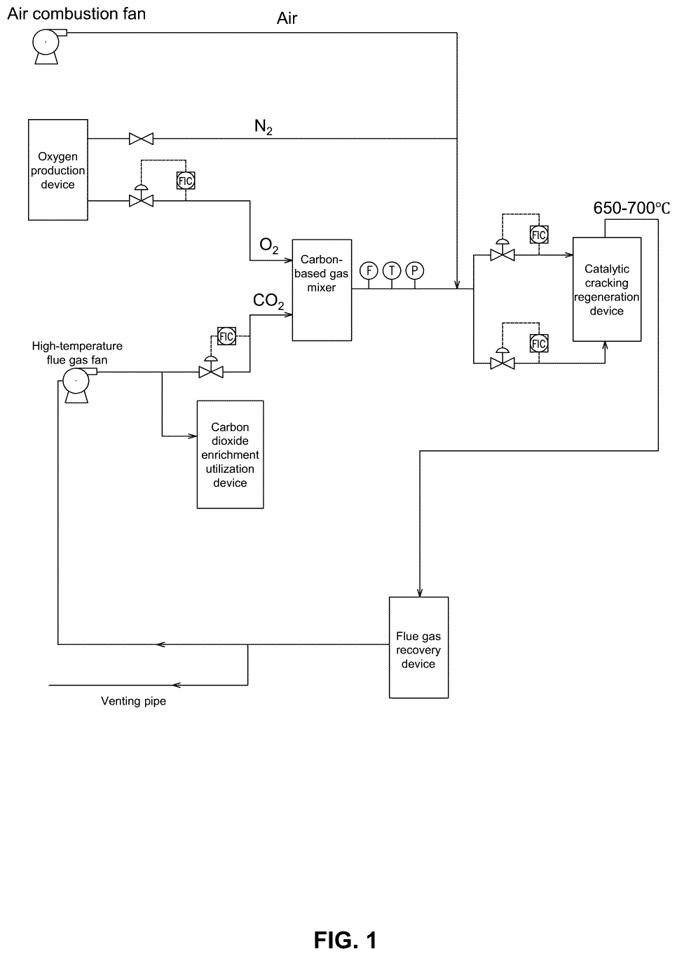

FIG. 1 is a schematic diagram illustrating a structure of a full recovery system for carbon dioxide according to some embodiments of the present disclosure. A full recovery system for carbon dioxide required for a process may include a catalytic cracking regeneration device, a flue gas recovery device, a flue gas fan, an oxygen production device, and a carbon-based gas mixer. In some embodiments, the full recovery system for carbon dioxide may further include a processor configured to control various components of the full recovery system for carbon dioxide to perform a full recovery process for carbon dioxide.

The oxygen production device may select a manner for producing oxygen according to different sizes of catalytic cracking regeneration devices, such as a cryogenic manner, a variable pressure adsorption manner, etc., the produced oxygen has a purity of equal to or greater than 90% and a pressure of 0.05-0.2 MPa, the purity being a mass percentage concentration.

For large-sized catalytic cracking regeneration devices, the cryogenic manner may be adopted to produce oxygen. Firstly, the air is compressed, cooled, and liquefied, and then a gas-liquid contact may be made in a distillation tray to perform mass-heat exchange based on different boiling points of oxygen and nitrogen components. The oxygen component with a high boiling point is constantly condensed into liquid from steam, and the nitrogen component with a low boiling point is constantly transferred into the steam, so that a nitrogen content in rising steam constantly increases, and an oxygen content in a downstream liquid becomes higher. Thus, oxygen and nitrogen may be separated to obtain oxygen with a purity of more than 99.6%, and a high-purity nitrogen may be obtained as a by-product.

For small and medium-sized catalytic cracking regeneration devices, the variable pressure adsorption manner may be adopted to produce oxygen. When the air passes through an adsorption layer of a molecular sieve adsorption tower after being pressurized, nitrogen molecules are adsorbed preferentially, and oxygen molecules are left in a gas phase to be a finished product of oxygen. When the nitrogen component in an adsorbent reaches saturation, the nitrogen molecules adsorbed on a surface of the adsorbent may be desorbed and sent out of a bounding region by using a decompression manner or a vacuuming manner to restore an adsorption capacity of the adsorbent. Accordingly, the oxygen and nitrogen may be separated to obtain the oxygen with a purity of 90-95% and the high-purity nitrogen as a by-product.

In some embodiments, an outlet of the flue gas fan may be provided with a safety valve and a back-pressure valve. When an outlet pressure is excessively high, a circulated flue gas may be returned to an inlet of the flue gas fan in time, thereby preventing the excessively high outlet pressure of the flue gas fan from causing adverse effects on the flue gas fan.

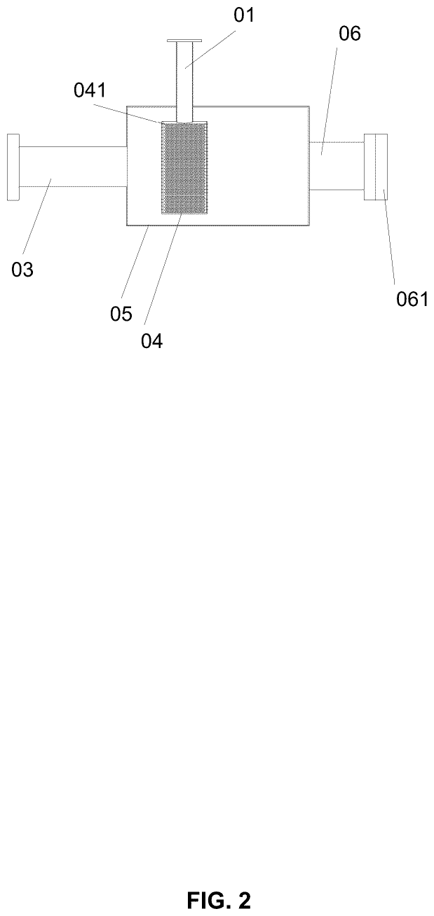

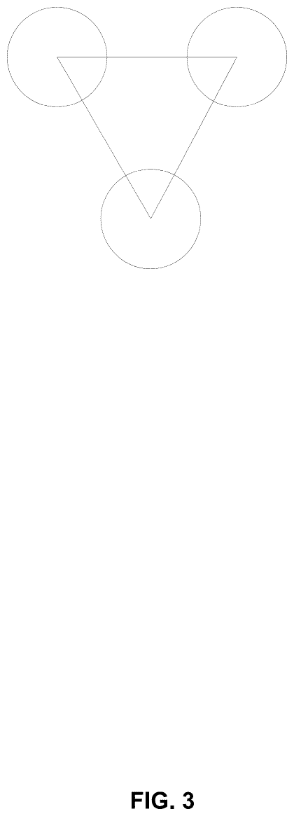

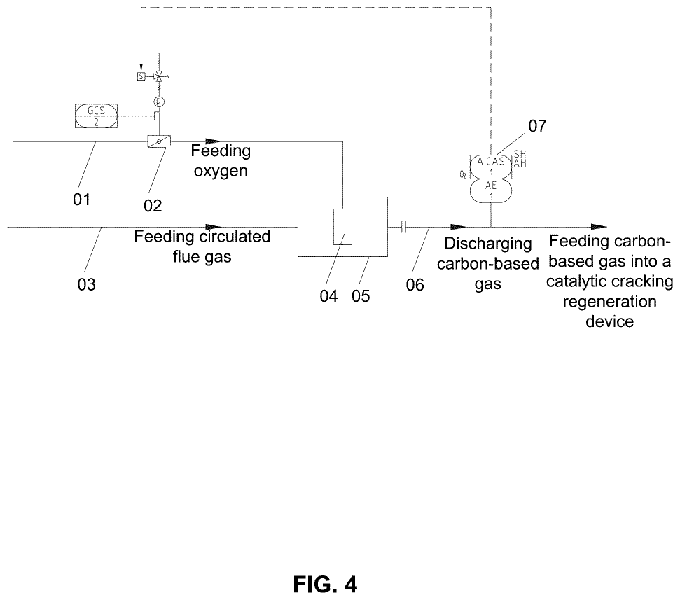

As illustrated in FIGS. 2-4, the carbon-based gas mixer may include an oxygen channel 01, an oxygen channel regulating valve 02, a flue gas recirculation channel 03, an oxygen distributor 04, a mixer 05, a carbon-based gas channel 06, and an oxygen concentration analyzer 07.

In some embodiments, the oxygen distributor 04 may be a first hollow cylinder, and a plurality of small holes 041 may be evenly provided on a peripheral wall of the first hollow cylinder. In some embodiments, three adjacent small holes 041 on the oxygen distributor 04 may be arranged in a same equilateral triangular shape, which may be more favorable for the oxygen to be rapidly and evenly mixed with the circulated flue gas after passing through the small holes 041. A diameter of each of the small holes 041 may be within a range of 5-10 mm, and an interval of the adjacent small holes 041 may be within, but is not limited to, a range of 5-10 mm.

In some embodiments, the mixer 05 may be a second hollow cylinder. The oxygen channel regulating valve 02 may be provided on the oxygen channel 01. An outlet of the oxygen channel 01 may be connected with an end of the oxygen distributor 04. The oxygen distributor 04 and a part of the oxygen channel 01 may be inserted into the mixer 05 through a side wall of the mixer 05. In some embodiments, the oxygen distributor 04 may be located on a side of the mixer 05 close to the flue gas recirculation channel 03, which is more favorable for rapid and even mixing of the oxygen and the circulated flue gas.

In some embodiments, an outlet of the flue gas recirculation channel 03 may be connected with one end of the mixer 05, an inlet of the carbon-based gas channel 06 may be connected with another end of the mixer 05, and the outlet of the carbon-based gas channel 06 may be used for a fixed connection by providing a flange 061. The oxygen concentration analyzer 07 may be provided on the carbon-based gas channel 06.

In some embodiments, the oxygen concentration analyzer 07 may be connected with the oxygen channel regulating valve 02 by a control system, so that a valve opening of the oxygen channel regulating valve 02 may be regulated based on data of the oxygen concentration analyzer 07. The oxygen channel 01 and the oxygen distributor 04 may be made of stainless steel. the flue gas recirculation channel 03, the mixer 05, and the carbon-based gas channel 06 may be made of stainless steel or carbon steel.

In some embodiments, a mixing and conveying process of the carbon-based gas may include the following operations. The circulated flue gas may enter the mixer 05 from the flue gas recirculation channel 03, the oxygen may enter the oxygen distributor 04 from the oxygen channel 01, the oxygen may be evenly distributed in the mixer 05 by the oxygen distributor 04 and may be rapidly and evenly mixed with the circulated flue gas, and then may be sent to the catalytic cracking regeneration device from the carbon-based gas channel 06. The oxygen concentration analyzer 07 may be provided on the carbon-based gas channel 06, and the valve opening of the oxygen channel regulating valve 02 may be controlled based on the data of the oxygen concentration analyzer 07, to further regulate an oxygen content of oxygen that enters into the mixer 05. The mixing may reach a balance when the oxygen content meets requirements.

When the oxygen is regulated, the valve opening of the oxygen channel regulating valve 02 may be regulated in an ascending manner. When a concentration of the oxygen meets the requirements, the valve opening of the oxygen channel regulating valve 02 may be fixed.

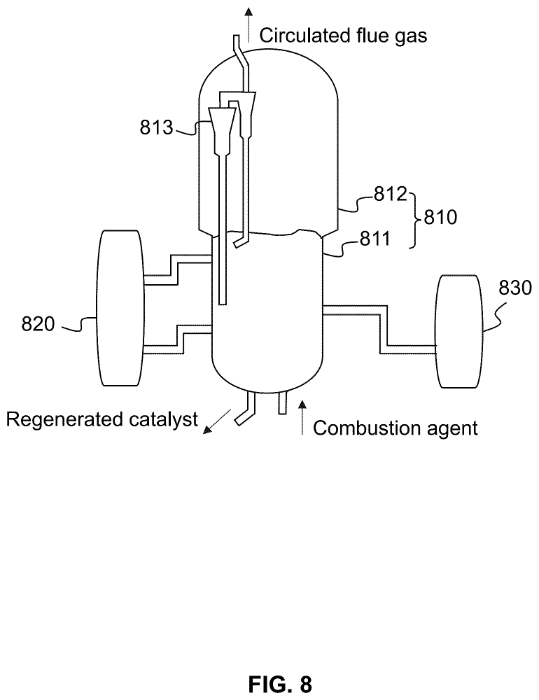

In some embodiments, the catalytic cracking regeneration device may be configured to undergo a combustion reaction to remove carbon deposits on a catalyst through a high temperature and high pressure environment, so as to restore the activity of the catalyst, and complete charring regeneration of the catalyst. A flue gas outlet may be provided at an upper portion of the catalytic cracking regeneration device for discharging the circulated flue gas generated by the reaction. As shown in FIG. 8, the catalytic cracking regeneration device may include a regenerator 810, a heat collector 820, and a catalyst storage system 830. Each component may be connected with each other through a pipeline

The regenerator 810 may include a dense phase region 811 and dilute phase region 812. The dense phase region 811 may be used for the charring regeneration of catalyst, and may be located at a lower portion of the regenerator. A combustion agent may enter the dense phase region 811 through the pipeline. A regenerated catalyst generated after the reaction may be discharged from the regenerator 810 through the pipeline. The dilute phase region 812 may be located at an upper portion of the regenerator. The carbon monoxide that is not burned up in the charring regeneration may further react with oxygen in the air to generate carbon dioxide in the dilute phase region, to ensure the complete combustion of the carbon deposits. The dilute phase region may also be provided with a separator 813 configured to separate and recover the catalyst and gas that complete the charring reaction.

The heat collector 820 may be configured to adjust temperature inside the regenerator, and may be disposed outside the regenerator to be connected with the dense phase region of the regenerator through a pipeline. For example, a part of the catalyst that completes the charring reaction in the dense phase region may be drawn out for cooling and then fed back to the regenerator, so as to adjust the temperature of the regenerator.

The catalyst storage system 830 may be configured to store and convey the catalyst, and may include a catalyst storage pipe, a pipeline, and a valve. The catalyst storage system may be connected with the dense phase region of the regenerator through the pipeline, so as to convey the catalyst to be regenerated to the dense phase region of the regenerator for charring regeneration.

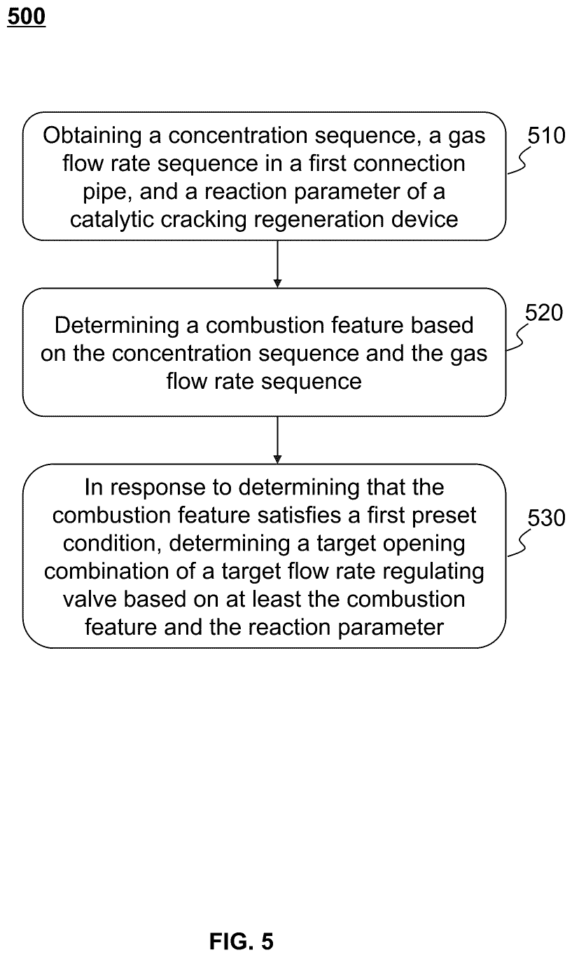

In some embodiments, the catalytic cracking regeneration device may further include a temperature sensor and a pressure sensor. More descriptions may be found in FIG. 5 and related descriptions thereof.

In some embodiments, the flue gas recovery device may be configured to process the circulated flue gas to complete at least one of heat recovery, dust removal, and desulfurization of the circulated flue gas. For example, the flue gas recovery device may include a waste heat boiler, a dust removal device, and a desulfurization device.

A heat exchanger and a working medium channel may be provided in the waste heat boiler. Water may be injected into the working medium channel as a working medium. When the circulated flue gas is discharged from the flue gas outlet of the catalytic cracking regeneration device, the circulated flue gas may enter the flue gas recovery device through the pipeline. The heat in the circulated flue gas may be transferred to the water in the working medium channel through the heat exchanger in the flue gas recovery device, so that the temperature of the water increases to generate water vapor. The water vapor may be sent back to the waste heat boiler or other heat utilization device to meet other heat energy requirements, thereby achieving the purpose of heat recovery. The dust removal device may be a cyclone separator, and may include inlet and outlet pipes, a bottom ash hopper, a cyclone, etc. in terms of structure. The dust removal device may be connected with the waste heat boiler through the inlet pipe and connected with the desulfurization device through the outlet pipe. When the circulated flue gas enters the dust removal device through the inlet pipe, the flue gas may form a high-speed rotating airflow under the action of the cyclone, and dust particles in the rotating airflow may be thrown to an outer cylinder wall under the action of a centrifugal force and move downward along a wall surface, and finally deposited in the bottom ash hopper. A purified flue gas may be discharged from the dust collector through the outlet pipe. The circulated flue gas purified by the dust removal equipment may enter the desulfurization equipment through the pipeline.

The desulfurization device may include a reaction tower, a demister, etc. The reaction tower may be configured to enable a desulfurizer to fully contact and react with the flue gas, the desulfurizer being zinc oxide. The purpose of removing hydrogen sulfide may be achieved by the reaction of the zinc oxide with the hydrogen sulfide to generate solid zinc sulfide and water. The demister may be configured to remove the water vapor in the flue gas.

In some embodiments, the flue gas recovery device may also be other devices or structures capable of performing heat recovery, dust removal, and desulfurization on the circulated flue gas.

In some embodiments, a flue gas outlet of the catalytic cracking regeneration device may be connected with the flue gas recovery device. The flue gas recovery device may be connected with the flue gas fan. A venting pipe may be provided on a connection pipe between the flue gas recovery device and the flue gas fan. When a volume of flue gas is too large, excess flue gas may be discharged. The flue gas fan may be connected with a carbon-based gas mixer and a downstream carbon dioxide enrichment utilization device, respectively. A first flow rate regulating valve may be provided on a third connection pipe between the flue gas fan and the carbon-based gas mixer. The downstream carbon dioxide enrichment utilization device may be used in the fields of oil and gas extraction, chemical application, food storage and preservation, etc.

An oxygen outlet of the oxygen production device may be connected with the carbon-based gas mixer. A fifth connection pipe between the oxygen outlet of the oxygen production device and the carbon-based gas mixer may be provided with a second flow rate regulating valve.

In some embodiments, the carbon-based gas mixer may be connected with a bottom portion and an upper portion of the catalytic cracking regeneration device, respectively. A main pipe of the carbon-based gas mixer and the bottom portion and the upper portion of the catalytic cracking regeneration device may be provided with a flow meter, a temperature sensor, and a pressure sensor. A branch pipe may be provided with a third flow rate regulating valve. The upper portion of the catalytic cracking regeneration device may be located at a position with a distance from the top portion of the catalytic cracking regeneration device being ⅕-⅖ of a distance from the bottom portion of the catalytic cracking regeneration device to the top portion of the catalytic cracking regeneration device.

In some embodiments, a nitrogen outlet of the oxygen production device may be connected with the main pipe of the bottom portion and the upper portion of the catalytic cracking regeneration device and the carbon-based gas mixer. The nitrogen, as the by-product, may be used as a protective gas for shutdown displacement, purging, cooling, and catalyst protection, which makes the device safer and more reliable. An original air combustion fan may be connected with the main pipe of the bottom portion and the upper portion of the catalytic cracking regeneration device and the carbon-based gas mixer, so that the volume of the flue gas may be replenished when the flue gas is insufficient. When an abnormality occurs in carbon-based gas combustion, the original air combustion fan may be switched to using air for combustion without any disturbance to ensure normal oxygen supply and combustion of the catalytic cracking regeneration device.

In some embodiments, the connection pipe between the flue gas outlet of the catalytic cracking regeneration device and the flue gas recovery device may be referred to as a first connection pipe. The connection pipe between the flue gas recovery device and the flue gas fan may be referred to as a second connection pipe. The connection pipe between the flue gas fan and the carbon-based gas mixer may be referred to as a third connection pipe. The connection pipe between the oxygen outlet of the oxygen production device and the carbon-based gas mixer may be referred to as a fourth connection pipe. The connection pipe between the bottom portion and the upper portion of the catalytic cracking regeneration device and the carbon-based gas mixer may be referred to as a fifth connection pipe. The fifth connection pipe may include the main pipe and the branch pipe. The connection pipe between the flue gas fan and the downstream carbon dioxide enrichment utilization device may be referred to as a sixth connection pipe.

In some embodiments, the flow rate regulating valve provided on the third connection pipe may be referred to as the first flow rate regulating valve. The flow rate regulating valve provided on the fourth connection pipe may be referred to as the second flow rate regulating valve. The flow rate regulating valve provided on the branch pipe of the fifth connection pipe may be referred to as the third flow rate regulating valve.

In some embodiments, the carbon dioxide enrichment utilization device may be configured to purify and compress and liquefy carbon dioxide. In some embodiments, the carbon dioxide enrichment utilization device may include a pressure swing adsorption (PSA) purification device and a compression and liquefaction device.

The PSA purification device is a pressure swing adsorption device that realizes gas separation and purification based on the principle of physical adsorption utilizing different adsorption and desorption properties of different components on adsorbents under pressure and temperature changes. In some embodiments, the PSA purification device may selectively remove a small amount of nitrogen, oxygen, and water vapor contained in the circulated flue gas to increase the purity of carbon dioxide to more than 99.9%. In some embodiments, the PSA purification device may include an adsorption tower, an air inlet valve, an exhaust valve, a desorption valve, and a pressure control system. The adsorption tower may be filled with a high-performance adsorbent, such as a molecular sieve, activated carbon, etc. The air inlet valve may be configured to control the entry of the circulated flue gas. The exhaust valve may be configured to discharge separated carbon dioxide. The desorption valve may be configured to introduce desorption gas to regenerate the adsorbent. Under a pressurized condition, the adsorbent selectively adsorbs impurity components, while the carbon dioxide smoothly passes through an adsorbent layer. The enriched carbon dioxide may be discharged from an outlet of the adsorption tower to enter the compression and liquefaction device.

The compression and liquefaction device may be configured to compress and liquefy gaseous carbon dioxide into liquid carbon dioxide for easy transportation and storage based on the principle of compression and expansion refrigeration. In some embodiments, the compression and liquefaction device may include a compressor, a heat exchanger, a liquefier, and related pipelines, valves, and control systems. The compressor may be configured to compress the gaseous carbon dioxide to a high-pressure state. The heat exchanger may be configured to cool a compressed high-temperature gas. In the liquefier, temperature of the compressed carbon dioxide gas may be further reduced and converted into the liquid carbon dioxide. In some embodiments, the carbon dioxide enrichment utilization device may also be other devices or structures capable of achieving purification, compression and liquefaction of carbon dioxide.

In some embodiments, the full recovery process for the carbon dioxide discharged from the catalytic cracking regeneration device may be executed by a processor of a full recovery system for carbon dioxide, including the following operations.

1) Air may be utilized for combustion at an initial stage, in response to generating the flue gas, a carbon-based gas may be made by mixing the circulated flue gas and the oxygen as a combustion agent to gradually replace the air for combustion. After circulation for 5-10 hours, the air may be completely replaced by the carbon-based gas for combustion, and the carbon-based gas for combustion may be in a normal operation, wherein a concentration of the carbon dioxide may be gradually increased to be at least 95% (removing water vapor).

2) In response to determining that the circulated flue gas enters the flue gas recovery device from the catalytic cracking regeneration device, the flue gas recovery device may be controlled to perform heat recovery, dedusting, and desulfurization on the circulated flue gas, and the flue gas fan may be controlled to pressurize the circulated flue gas to 0.05-0.2 MPa. A part of a pressurized circulated flue gas may be introduced into the carbon-based gas mixer via the third connection pipe, and rest of the pressurized circulated flue gas may be introduced into the downstream carbon dioxide enrichment utilization device via the fourth connection pipe. A purity of the oxygen produced by the oxygen production device may be equal to or greater than 90%, and a pressure of the oxygen produced by the oxygen production device may be within a range of 0.05-0.2 MPa. The oxygen produced may be introduced into the carbon-based gas mixer. The oxygen and the circulated flue gas may be mixed in the carbon-based gas mixer to produce the carbon-based gas. The oxygen volume content of the carbon-based gas may be within a range of 15-30%.

3) The carbon-based gas may be used as the combustion agent, and a staged oxygen combustion technology may be adopted. The carbon-based gas mixer may be controlled to introduce the carbon-based gas to the bottom portion and the upper portion of the catalytic cracking regeneration device in two ways. 98-99% of the volume of the carbon-based gas may enter the bottom portion of the catalytic cracking regeneration device as a main combustion agent to provide a majority of the combustion gas for combustion of a catalyst carbon deposit in the catalytic cracking regeneration device, and 1-2% of the volume of the carbon-based gas may enter the upper portion of the catalytic cracking regeneration device as an auxiliary combustion agent to provide the combustion gas for a small count of carbon monoxide that is not burned up in the catalytic cracking regeneration device. A regeneration temperature in the catalytic cracking regeneration device may be controlled to be within a range of 650-700° C.

4) The catalytic cracking regeneration device may be controlled to feed the generated circulated flue gas to the flue gas recovery device via the first connection pipe, and operation 2) and operation 3) may be performed again, and the above operations may be repeated until a preset condition is satisfied. The preset condition may include a processing duration satisfying a duration requirement.

The full recovery process for the carbon dioxide discharged from the catalytic cracking regeneration device provided in some embodiments of the present disclosure has following beneficial effects.

(1) The carbon dioxide may be enriched by circulating the flue gas produced by the catalytic cracking regeneration device to the concentration of at least 95%, the concentration being a volume percentage concentration. The higher the concentration of the carbon dioxide, the easier the capture of the carbon dioxide, and the more favorable conditions it creates for low-cost carbon capture, utilization, and storage (CCUS), which can reduce carbon dioxide emission and lower the greenhouse effect.

(2) The carbon-based gas required for the catalytic cracking regeneration device may be prepared by mixing the circulated flue gas and the oxygen, and the carbon-based gas may be used as the combustion assisting gas of the catalytic cracking regeneration device. The nitrogen may be replaced with the carbon dioxide, eliminating the generation of nitrogen oxides and avoiding the nitrogen oxides during the combustion process, thereby reducing environmental pollution, and greatly reducing the cost of denitrification. A conventional mechanism of combustion with air may be represented by CₘHₙ+O₂+N₂→CO₂+H₂O+NOₓ. In some embodiments of the present disclosure, a mechanism of combustion with the carbon-based gas (CO₂+O₂) may be represented by CₘHₙ+O₂+CO₂→CO₂+H₂O.

(3) According to characteristics of gas convection and radiation, only tri-atomic and poly-atomic gases have capacity of radiating, and diatomic gases have almost no ability to radiate. The nitrogen in the air may be replaced with the carbon dioxide in the circulated flue gas for combustion, which greatly enhances a radiation intensity in the catalytic cracking regeneration device. Under a carbon dioxide atmosphere, a reaction of C+CO₂→CO may be promoted, and carbon monoxide is easier to be completely burned than residual carbon adsorbed in the catalyst. Thus, a combustion effect may be greatly enhanced to make the reaction more complete and achieve a remarkable effect of energy conservation and consumption reduction.

(4) The carbon-based gas may be used as the combustion agent for the combustion of the catalyst carbon deposit in the catalytic cracking regeneration device, and the staged oxygen combustion technology may be used to feed the carbon-based gas into the bottom portion and the upper portion of the catalytic cracking regeneration device in two ways. 98-99% of the volume fraction of the carbon-based gas may enter the bottom portion of the catalytic cracking regeneration device as the main combustion agent to provide the majority of the combustion gas for the combustion of the catalyst carbon deposit in the catalytic cracking regeneration device, and 1-2% of the volume fraction of the carbon-based gas may enter the upper portion of the catalytic cracking regeneration device as the auxiliary combustion agent to provide the combustion gas for the small count of carbon monoxide that is not burned up in the catalytic cracking regeneration device. Therefore, the combustion in the catalytic cracking regeneration device can be more complete, which effectively solves the problem of trailing combustion, ensuring the safety of the device, and greatly reducing the safety risk.

(5) By optimizing a combustion environment, a temperature distribution in the catalytic cracking regeneration device may be more reasonable, which effectively extends a service life of the catalytic cracking regeneration device. Improvement of a combustion condition may make the regeneration of the catalyst more thorough, which prolongs a service life of the catalyst, reduces consumption of the catalyst, and improves the quality of products.

(6) By using flue gas recirculation, a water vapor content of the flue gas may be increased, allowing more heat to be recovered and power generation.

(7) Nitrogen, the by-product of the oxygen production device, may be used as the protective gas for the catalytic cracking regeneration device for shutdown displacement, purging, cooling, and catalyst protection, which makes the device safer and more reliable.

(8) A structure of the catalytic cracking regeneration device does not need to be changed, and only the combustion system and the circulated flue gas system may be partially optimized and modified. In addition, the original air combustion fan may be retained, so that the volume of the flue gas may be replenished when the flue gas is insufficient. When an abnormality occurs in carbon-based gas combustion, the original air combustion fan may be switched to using air for combustion without any disturbance to ensure normal oxygen supply and combustion of the catalytic cracking regeneration device.

In some embodiments, a concentration detecting device and a gas flow rate sensor may be provided on a connection pipe between the flue gas outlet of the catalytic cracking regeneration device and the flue gas recovery device. A temperature sensor and a pressure sensor may be provided in the catalytic cracking regeneration device.

The concentration detecting device may be configured as a detecting device that records and collects information about concentrations of different components in the flue gas. In some embodiments, the concentration detecting device may include one or more concentration sensors, and detected constituents corresponding to the concentration sensors may be the same or different. The concentration sensors may obtain information of a concentration of a corresponding constituent and send the information of the concentration of the corresponding constituent to the processor. Merely by way of example, the concentration detecting device may include a carbon monoxide concentration sensor, a carbon dioxide concentration sensor, and an oxygen concentration sensor.

In some embodiments, the processor may obtain a concentration sequence and a gas flow rate sequence of carbon monoxide in the connection pipe via the concentration detecting device and the gas flow rate sensor, and obtain a reaction parameter of the catalytic cracking regeneration device via the temperature sensor and the pressure sensor. The processor may determine an opening combination of at least one flow rate regulating valve in the connection pipe based on the concentration sequence, the gas flow rate sequence, and the reaction parameter.

FIG. 5 is a flowchart illustrating an exemplary process of determining an opening combination of a flow rate regulating valve according to some embodiments of the present disclosure. As shown in FIG. 5, a process 500 may include the following operations. In some embodiments, the process 500 may be executed by a processor.

In 510, a concentration sequence and a gas flow rate sequence in a first connection pipe, and a reaction parameter of a catalytic cracking regeneration device may be obtained.

The concentration sequence refers to sequential data including a plurality of carbon monoxide concentrations. For example, the plurality of carbon monoxide concentrations may include a carbon monoxide concentration of at least one time point in the connection pipe.

In some embodiments, the concentration sequence may be represented by a vector. For example, if the carbon monoxide concentrations collected at 6:10, 6:20, and 6:30 are 5%, 7%, and 10%, respectively, concentration sequences corresponding to the carbon monoxide concentrations may be [(6:10,5), (6:20,7), (6:30,10)]. In some embodiments, the processor may be coupled to one or more concentration sensors of the concentration detecting device to obtain carbon monoxide concentrations of different time points to determine the concentration sequence.

The gas flow rate sequence refers to sequential data including a plurality of gas flow rate information. For example, the plurality of gas flow rate information may include gas flow rate information of at least one time point in the connection pipe. In some embodiments, a gas flow rate may be positively correlated to a production efficiency of a post-combustion product. For example, the higher the gas flow rate, the more gas is produced by combustion, and the greater a reaction rate of the combustion. In some embodiments, the processor may obtain the gas flow rate information of different time points through a gas flow rate sensor to determine the gas flow rate sequence. The gas flow rate sequence may be composed in a form similar to the concentration sequence, which may be found in related descriptions regarding the concentration sequence.

The reaction parameter refers to an indicator to measure at least one of a reaction degree, a reaction environment, and a reaction condition in the reaction of the catalytic cracking regeneration device. In some embodiments, the reaction parameter may include at least one of a reaction temperature, a reaction pressure, and a structural parameter. The structural parameter refers to an indicator related to a physical structure of the catalytic cracking regeneration device, such as a volume, a diameter, a surface area, etc.

In some embodiments, the processor may determine the reaction parameter based on data obtained from internal sensors in the catalytic cracking regeneration device. For example, the processor may collect data such as the reaction pressure, the reaction temperature, etc., at different positions in the catalytic cracking regeneration device. In some embodiments, the processor may also obtain the structural parameter, etc., from a storage. The structural parameter may be represented in a plurality of forms, such as a three-dimensional model, etc. The structural parameter of the catalytic cracking regeneration device may be provided by a relevant production unit of the catalytic cracking regeneration device and stored in the storage in advance.

In some embodiments, the internal sensors in the catalytic cracking regeneration device may include a second temperature sensor and a second pressure sensor. The second temperature sensor and the second pressure sensor may be used in a high-temperature environment. In some embodiments, the internal sensors may also include other sensors such as a light intensity sensor, a flow rate sensor, etc., a count and type of the sensors may not be limited in the present disclosure.

In 520, a combustion feature may be determined based on the concentration sequence and the gas flow rate sequence.

The combustion feature refers to data that reflects combustion conditions within the catalytic cracking regeneration device. In some embodiments, the combustion feature may include at least one of a combustion degree, a combustion stabilization degree, and a reaction rate.

The combustion degree refers to an extent to which reactants inside the device are fully burned. The combustion stabilization degree may reflect a fluctuation degree of a target product generated by combustion of the reactants over time. The reaction rate reflects an intensity of combustion of the reactants inside the device. The combustion degree, the combustion stabilization degree, and the reaction rate may be expressed by numerical values, grades, etc. For example, the larger the value of the combustion degree, the more adequate the combustion is within the catalytic cracking regeneration device, and the lower the amount of carbon monoxide produced due to inadequate combustion. The smaller the value of the combustion stabilization degree, the more stable the combustion condition inside the catalytic cracking regeneration device and the smaller the fluctuation over time. The larger the value of the reaction rate, the more intense the combustion condition inside catalytic cracking regeneration device and the larger the rate of consuming the reactants. The reactants may include carbon deposit, oil deposit, etc., and the target product may include gases generated by the combustion of carbon dioxide, etc.

In some embodiments, the processor may also determine the combustion feature based on the concentration sequence and the gas flow rate sequence. For example, a full combustion degree may be negatively correlated to a value of the carbon monoxide concentration, the combustion stabilization degree may be negatively correlated to a fluctuation of the carbon monoxide concentration, and the reaction rate may be positively correlated to an average value of a gas flow rate of the carbon monoxide.

Merely by way of example, the processor may determine the combustion feature based on equation (1)-equation (4):

$$F = \sqrt{\frac{{\sum }_{i = 1}^{n} {( {x}_{i} - \overline{x} )}^{2}}{n}} \qquad ( 1 )$$

$$U = 100 \% - \overline{x} \qquad ( 2 )$$

$$\overline{x} = \frac{{x}_{1} + {x}_{2} + … + {x}_{n}}{n} \qquad ( 3 )$$

$$η = \frac{{V}_{1} + {V}_{2} + … + {V}_{n}}{n} \qquad ( 4 )$$

Where F denotes the combustion stabilization degree, U denotes the full combustion degree, x̅ denotes the average value of the carbon monoxide concentration, η denotes the reaction rate, xₙ denotes a carbon monoxide concentration of an nth time point, and Vₙ denotes a gas flow rate of the nth time point.

In 530, in response to determining that the combustion feature satisfies a first preset condition, a target opening combination of a target flow rate regulating valve may be determined based on at least the combustion feature and the reaction parameter.

The first preset condition refers to a condition for determining whether the combustion feature of a current device satisfies a requirement. In some embodiments, the first preset condition may include following two situations. In situation 1, the combustion stabilization degree may be less than a stabilization threshold and the full combustion degree may be less than a combustion threshold. In situation 2, the combustion stabilization degree may be less than the stabilization threshold and the reaction rate may be less than a rate threshold. The stabilization threshold, the combustion threshold, and the rate threshold may be preset based on priori experience and/or historical data. When the combustion feature of the device satisfies any one of the situations, the first preset condition may be regarded as being satisfied.

The target opening combination refers to a combination of operating parameters for one or more target flow rate regulating valves. The target flow rate regulating valve may include all flow rate regulating valves in the full recovery system for the carbon dioxide discharged from the catalytic cracking regeneration device.

In some embodiments, the target opening combination may include information related to operating states (e.g., a working state, a standby state, a shutdown state, etc.), opening magnitudes of flow rates (e.g., fully open, 50% open, fully closed, etc.), etc., of different target flow rate regulating valves.

In some embodiments, the target opening combination may be represented by a vector. For example, a valve 1 may be in the shutdown state, with an opening amplitude of a flow rate of being fully closed; a valve 2 may be in the working state, with an opening amplitude of a flow rate of being fully open; a valve 3 may be in the working state, with an opening amplitude of a flow rate of being 50% open; and a valve 4 may be in the standby state, with an opening amplitude of a flow rate of being fully closed. Then the target opening combination may be [(valve 1, working, 50%), (valve 2, working, 100%), (valve 3, working, 50%), (valve 4, standby, 0%)].

Merely by way of example, in response to determining that the combustion feature satisfies the first preset condition, the processor may determine the target opening combination based on the reaction rate, the full combustion degree, and the average value of the carbon monoxide concentration of the catalytic cracking regeneration device by querying a first preset table. The first preset table may include preset correspondence relationships between the reaction rate, the full combustion degree, the average value of the carbon monoxide concentration, etc., for various values, and the target opening combination. The first preset table may be constructed based on historical data.

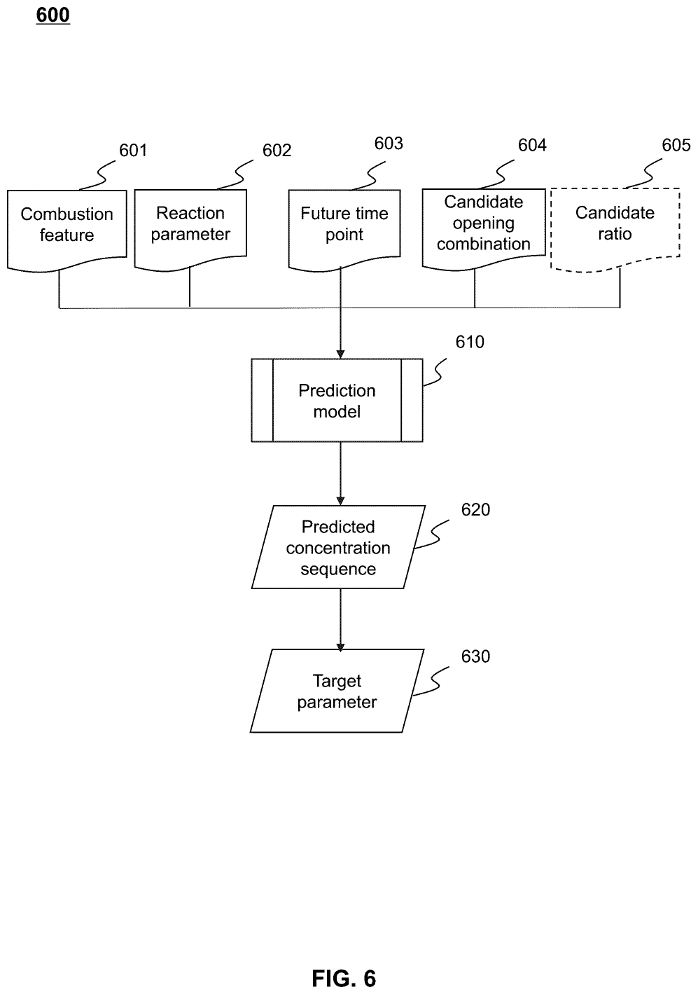

In some embodiments, in response to determining that the combustion feature satisfies the first preset condition, the processor may also determine the target opening combination of the target flow rate regulating valve based on the combustion feature and the reaction parameter via a prediction model. More descriptions regarding the prediction model may be found in FIG. 6 and related descriptions thereof.

In some embodiments of the present disclosure, the target opening combination of the target flow rate regulating valve may be regulated in real-time to optimize an effect of carbon combustion removal by monitoring parameters such as the carbon monoxide concentration, the gas flow rate, etc. at positions such as the flue gas outlet and the recovery device, thereby improving combustion efficiency and production and operation efficiency.

FIG. 6 is a schematic diagram illustrating an exemplary prediction model according to some embodiments of the present disclosure.

In some embodiments, a target opening combination of a target flow rate regulating valve may also be determined by following operations. At least one set of candidate parameters may be generated, and the at least one set of candidate parameters may include a candidate opening combination of the target flow rate regulating valve. A predicted concentration sequence corresponding to the candidate opening combination may be predicted through a prediction model. A target parameter may be determined based on a predicted combustion feature.

The candidate parameters refer to a set or a plurality of sets of alternate regulation parameters for combustion operation. In some embodiments, the candidate parameters may include at least one or a plurality of sets of candidate opening combinations of the target flow rate regulating valve.

The processor may generate the candidate parameters in a plurality of ways. In some embodiments, the processor may construct a vector to be matched based on the combustion feature such as the full combustion degree, the combustion stabilization degree, the reaction rate, etc. of the catalytic cracking regeneration device. The processor may search in a vector database based on the vector to be matched to obtain a reference vector whose vector distance from the vector to be matched is less than a distance threshold, and the processor may determine a historical parameter preset range corresponding to the reference vector as a parameter preset range currently required. The processor may randomly generate a plurality of sets of control parameters based on the parameter preset range and determine the plurality of sets of control parameters as the candidate parameters. The vector database may be configured to store a plurality of historical vectors and historical parameter preset ranges corresponding to the plurality of historical vectors. The vector database may be constructed based on a historical full combustion degree, a historical combustion stabilization degree, a historical reaction rate, and the corresponding historical parameter preset ranges.

In some embodiments, the processor may predict, based on the candidate parameters, a predicted concentration sequence 620 corresponding to the candidate parameters based on a prediction model 610.

The prediction model refers to a model for predicting a concentration sequence in a future period. In some embodiments, the prediction model may be a machine learning model, such as a neural network (NN) model, or another customized model structure, or the like, or any combination thereof.

In some embodiments, an input of the prediction model 610 may include a combustion feature 601, a reaction parameter 602 of the catalytic cracking regeneration device, a future time point 603, and a candidate opening combination 604. An output of the prediction model 610 may include a predicted concentration sequence 620 of a connection pipe of at least one future time point under the candidate opening combination 604.

The future time point refers to a time node of one or more future moments. In some embodiments, the future time point may be represented by a vector, and the processor may take a preset count of time points starting from a current time point at a preset time interval as the future time point. For example, the preset time interval may be two minutes, and the preset count of time points may be five. If the current time point is 8:00, the future time points are [8:02, 8:04, 8:06, 8:08, 8:10].

In some embodiments, the preset time interval may also be any value, such as [8:02, 8:03, 8:16, 8:28, 9:29], etc., which is not limited with respect to a value of the preset time interval. The candidate opening combination refers to an opening combination included in the candidate parameters. More descriptions regarding the combustion feature, the candidate parameters, and the reaction parameter may be found in FIG. 5 and related descriptions thereof.

The predicted concentration sequence refers to a sequence composed of a carbon monoxide concentration obtained by prediction, and a corresponding future time point. In some embodiments, the predicted concentration sequence may be represented by a vector, and a manner for constructing the predicted concentration sequence may be similar to a manner for constructing the concentration sequence, which may be found in FIG. 5 and related descriptions thereof.

The prediction model may be obtained by training at least one set of training samples and labels corresponding to the at least one set of training samples. In some embodiments, the training samples may include at least one set of historical data. Each set of historical data may include a historical combustion feature and a historical reaction parameter corresponding to a historical first time point, a historical second time point, and a historical opening combination. The labels corresponding to the at least one set of training samples may be a historical concentration sequence corresponding to a historical second time point. The historical second time point may be later than the historical first time point.

During training, the training samples may be input into an initial prediction model and a loss function may be constructed based on an output of the initial prediction model and the labels. Parameters of the initial prediction model may be updated through iterations based on the loss function, the training may be completed until the parameters satisfy a preset condition, and a trained prediction model may be obtained. The preset condition may include but is not limited to, the loss function converging, a training period reaching a threshold, etc.

In some embodiments of the present disclosure, by using a large count of historical data to train the prediction model and then determining the predicted concentration sequence by the prediction model, a change in the carbon monoxide concentration at the future time point may be better predicted, thereby improving accuracy of the predicted combustion feature to ensure that the finally obtained target opening combination may accurately and reliably regulate the flow rate regulating valve.

The target parameter refers to a set of parameters for regulating the target flow rate regulating valve, which is obtained after screening from one set or the plurality sets of candidate parameters. In some embodiments, the target parameter may include at least the target opening combination of the target flow rate regulating valve. More description regarding the target flow rate regulating valve and the target opening combination may be found in FIG. 5 and related descriptions thereof.

The processor may determine the target parameter in a plurality of ways. In some embodiments, the processor may determine future combustion features corresponding to different candidate parameters based on the predicted concentration sequence 620 obtained by the prediction model 610 and retain only candidate parameters that satisfy a first determination condition. The first determination condition may include that the combustion stabilization degree at the future time point is less than the stabilization threshold. The retained candidate parameters may be ranked according to the full combustion degree at the future time point. A candidate parameter that has a greatest full combustion degree at the future time point may be selected as the target parameter 630.

The future combustion feature refers to a combustion feature at a future time point. In some embodiments, the future combustion feature may contain the same indicators as those contained in the combustion feature, which may be found in the description related to the combustion feature in FIG. 5.

In some embodiments, the processor may determine the future combustion feature based on the combustion feature, the reaction parameter, and the predicted concentration sequence by querying a second preset table. In some embodiments, the second preset table may include combustion features, reaction parameters, and predicted concentration sequences with different values, and corresponding future combustion features. In some embodiments, the second preset table may be constructed based on historical data.

In some embodiments, the processor may also determine the future combustion features corresponding to different candidate parameters based on the predicted concentration sequence obtained by the prediction model and retain only candidate parameters that satisfy a second determination condition. The second determination condition may include that the combustion stabilization degree at the future time point is less than the stabilization threshold and the full combustion degree at the future time point is greater than the combustion threshold. The retained candidate parameters may be ranked based on a risk degree. A candidate parameter with a smallest risk degree may be selected as the target parameter.

The risk degree refers to a possibility of a hazard occurring in the full recovery system for carbon dioxide when the candidate parameter is taken as the target parameter.

In some embodiments, the processor may determine the risk degree of the full recovery system based on a candidate opening combination in the candidate parameters by querying a third preset table. In some embodiments, the third preset table may include different candidate opening combinations and potential abnormal conditions in the system and risk levels corresponding to different candidate opening combinations.

In some embodiments, the third preset table may be pre-constructed based on historical opening combinations, and historical potential abnormal conditions in the system and historical risk levels during operation of the historical opening combinations. The potential abnormal condition in the system may include whether an abnormal condition has occurred, a type of the abnormal condition that has occurred (e.g., a combustion, an explosion, a leakage), etc. The risk level may reflect a severity corresponding to different abnormal conditions and may be expressed in numbers 1 to 10. The larger the number is, the more severe the abnormal condition. For example, if a risk of explosion is greater than a risk of leakage, a risk level of the explosion may be 10, and a risk level of leakage may be 3.

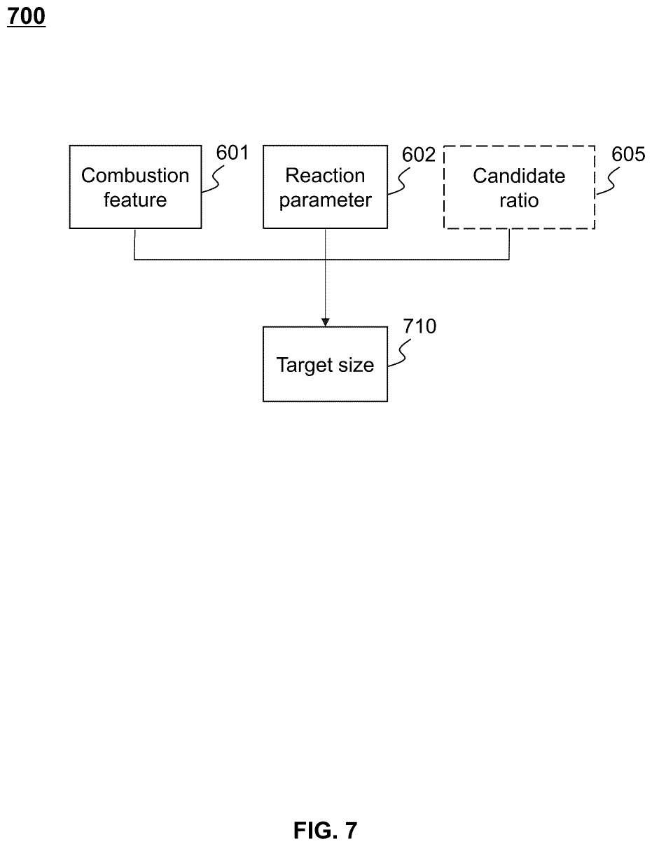

In some embodiments, the candidate parameter may also include a candidate ratio of an upper portion to a top portion of the catalytic cracking regeneration device, which may be used to determine a ratio of the upper portion of the catalytic cracking regeneration device to the top portion of the catalytic cracking regeneration device. More descriptions may be found in FIG. 7.

FIG. 7 is a schematic diagram illustrating a process of determining a target size according to some embodiments of the present disclosure.

In some embodiments, in response to determining that a combustion feature satisfies a second preset condition, a target size 710 of a catalytic cracking regeneration device may be determined based on at least the combustion feature 601 and the reaction parameter 602.

The second preset condition refers to a condition for determining whether a combustion condition within a current device is adequate. In some embodiments, the second preset condition may include that a combustion stabilization degree is greater than a stabilization threshold. More descriptions regarding the stabilization threshold may be found in descriptions related to a first preset condition.

The target size refers to a positional relationship between an active connection site and a carbon-based gas mixer when the carbon-based gas mixer is detachably connected with an upper portion of the catalytic cracking regeneration device. In some embodiments, the target size may include a target ratio.

The target ratio refers to a ratio of a distance between the active connection site in the upper portion of the catalytic cracking regeneration device and a top portion of the catalytic cracking regeneration device to a height of the catalytic cracking regeneration device.

Merely by way of example, the processor may obtain the target ratio based on equation (5):

$$σ = \frac{{L}_{H}}{{L}_{A}} \times 100 \% \qquad ( 5 )$$

Where σ denotes the target ratio, L_{H} denotes the distance between the active connection site to the top portion of the catalytic cracking regeneration device, and L_{A} denotes the height of the catalytic cracking regeneration device.

The processor may determine the target size in a plurality of ways. In some embodiments, in response to determining that the combustion feature satisfies the second preset condition, the processor may determine the target size based on the combustion feature and the reaction parameter of the catalytic cracking regeneration device by querying a fourth preset table. The fourth preset table may include preset correspondence relationships between a combustion rate, a reaction parameter of the catalytic cracking regeneration device, etc., with various values, and the target size. The fourth preset table may be constructed based on historical data.

When combustion in the catalytic cracking regeneration device is unstable, the ratio of the upper portion to the top portion of the catalytic cracking regeneration device may be too small, which causes an insufficient mixing of combustion assisting gases and carbon monoxide, leading to inadequate combustion. In this case, adequate combustion needs to be ensured first, and factors such as a carbon monoxide concentration, etc. may be further considered. The combustion feature may be determined by the second preset condition and the target ratio may be regulated, so that stability of a combustion process is further improved, thereby reducing generation probability of carbon monoxide, and promoting full combustion of reactants.

In some embodiments, the processor may also obtain the target size 710 based on the prediction model 610. In this case, an input of the prediction model may also include a candidate ratio 605, and an output of the prediction model may also include the target ratio 710. Training samples may include a plurality of sets of historical data. Each of the plurality of sets of historical data may include a historical combustion feature and historical reaction parameter corresponding to a historical first time point, a historical second time point, a historical opening combination, and a historical ratio. Training labels corresponding to the training samples may include a historical concentration sequence corresponding to the historical second time point, and a historical target ratio. The historical second time point may be later than the historical first time point. When the prediction model is trained, a loss function may be constructed based on a historical concentration sequence and a historical target ratio, and a concentration sequence and a target ratio output by an initial prediction model, and parameters of the initial prediction model may be updated through at least one round of iteration. A specific training process may be found in related descriptions hereabove.

The candidate ratio refers to a ratio of a distance between the upper portion of the one or more sets of alternate catalytic cracking regeneration devices and the top portion of the one or more sets of alternate catalytic cracking regeneration devices to the height of the one or more sets of alternate catalytic cracking regeneration devices. In some embodiments, the processor may determine the candidate ratio in a plurality of ways. For example, the processor may obtain a plurality of sets of historical target sizes based on the historical data and designate historical target ratios contained in the plurality of sets of historical target sizes as the candidate ratios. In some embodiments, the processor may also randomly determine the plurality of sets of candidate ratios at a position with a distance from the top portion of the catalytic cracking regeneration device being ⅕-⅖ of a distance from the bottom portion of the catalytic cracking regeneration device to the top portion of the catalytic cracking regeneration device.

In some embodiments of the present disclosure, by using the prediction model, factors such as the candidate opening combinations, the future time points, etc., may be fully considered, thereby determining the target ratio more accurately.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and modifications are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the invention. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. In closing, it is to be understood that the embodiments of the present disclosure disclosed herein are illustrative of the principles of the embodiments of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A full recovery process for carbon dioxide discharged from a catalytic cracking regeneration device, wherein the process is implemented based on a processor of a full recovery system for carbon dioxide, the full recovery system for carbon dioxide includes the catalytic cracking regeneration device, a flue gas recovery device, a flue gas fan, an oxygen production device, and a carbon-based gas mixer; wherein
the carbon-based gas mixer includes an oxygen channel, an oxygen channel regulating valve, a flue gas recirculation channel, an oxygen distributor, a mixer, a carbon-based gas channel, and an oxygen concentration analyzer; wherein
the oxygen distributor is a hollow cylinder, and a plurality of small holes are evenly provided on a peripheral wall of the hollow cylinder; the mixer is a hollow cylinder; the oxygen channel regulating valve is located on the oxygen channel, and an outlet of the oxygen channel is connected with an end of the oxygen distributor, the oxygen distributor and a part of the oxygen channel are inserted into the mixer through a side wall of the mixer; an outlet of the flue gas recirculation channel is connected with one end of the mixer, and an inlet of the carbon-based gas channel is connected with another end of the mixer, and the oxygen concentration analyzer is provided on the carbon-based gas channel;
the catalytic cracking regeneration device, configured as a position of combustion, includes a flue gas outlet, a temperature sensor, and a pressure sensor;
the flue gas recovery device is configured to process circulated flue gas, and includes a waste heat boiler, a dust removal device, and a desulfurization device; the dust removal device being connected with the waste heat boiler through an inlet pipe, and connected with the desulfurization device through an outlet pipe;
the flue gas outlet is connected with the flue gas recovery device through a first connection pipeline, the flue gas recovery device is connected with the flue gas fan through a second connection pipeline, and a venting pipe is provided on the second connection pipeline; the flue gas fan is connected with the carbon-based gas mixer through a third connection pipeline, and a first flow rate regulating valve is provided on the third connection pipeline;
an oxygen outlet of the oxygen production device is connected with the carbon-based gas mixer through a fourth connection pipeline, and a second flow rate regulating valve is provided on the fourth connection pipe;
the carbon-based gas mixer is connected with a bottom portion and an upper portion of the catalytic cracking regeneration device through a fifth connection pipeline, respectively, the fifth connection pipeline includes a main pipe and a branch pipe, the main pipe is provided with a flow meter, a first temperature sensor, and a first pressure sensor, and the branch pipe is provided with a third flow rate regulating valve; and
a nitrogen outlet of the oxygen production device is connected to the main pipe, and an air combustion fan is connected to the main pipe; and
the process includes:
1) utilizing air for combustion at an initial stage, in response to generating a flue gas, utilizing a carbon-based gas made by mixing the circulated flue gas and oxygen as a combustion agent to gradually replace the air for combustion, and after a period of circulation, completely replacing the air with the carbon-based gas for combustion, the carbon-based gas for combustion being in a normal operation;
2) in response to determining that the circulated flue gas enters the flue gas recovery device from the catalytic cracking regeneration device, controlling the flue gas recovery device to perform heat recovery, dedusting, and desulfurization on the circulated flue gas; controlling the flue gas fan to pressurize the circulated flue gas, introducing part of a pressurized circulated flue gas into the carbon-based gas mixer via the third connection pipe; controlling the oxygen production device to introduce the oxygen into the carbon-based gas mixer, and mixing the oxygen and the circulated flue gas in the carbon-based gas mixer to produce the carbon-based gas;
3) controlling the carbon-based gas mixer to introduce the carbon-based gas into the bottom portion and the upper portion of the catalytic cracking regeneration device in two ways, wherein the carbon-based gas entering into the bottom portion of the catalytic cracking regeneration device is a main combustion agent providing a majority of a combustion gas for combustion of a catalyst carbon deposit in the catalytic cracking regeneration device, and the carbon-based gas entering into the upper portion of the catalytic cracking regeneration device is an auxiliary combustion agent providing the combustion gas for a small count of carbon monoxide that is not burned up in the catalytic cracking regeneration device; and
4) controlling the catalytic cracking regeneration device to feed a generated circulated flue gas to the flue gas recovery device via the first connection pipe, and performing operation 2) and operation 3) again.

2. The full recovery process of claim 1, wherein three adjacent small holes on the oxygen distributor in the carbon-based gas mixer are arranged in a same equilateral triangular shape; and the oxygen distributor is located on a side of the mixer close to the flue gas recirculation channel.

3. The full recovery process of claim 1, wherein the upper portion of the catalytic cracking regeneration device is located at a position with a distance from the top portion of the catalytic cracking regeneration device being ⅕-⅖ of a distance from the bottom portion of the catalytic cracking regeneration device to the top portion of the catalytic cracking regeneration device.

4. The full recovery process of claim 1, wherein a concentration of the carbon dioxide of the circulated flue gas produced by the catalytic cracking regeneration device in operation 2) is at least 95%.

5. The full recovery process of claim 1, wherein the circulated flue gas in operation 2) is partially introduced into the carbon-based gas mixer after being pressurized to a range of 0.05-0.2 MPa by the flue gas fan.

6. The full recovery process of claim 1, wherein a purity of the oxygen produced by the oxygen production device in operation 2) is greater than or equal to 90%, the purity being a mass percentage concentration, and a pressure of the oxygen produced by the oxygen production device in operation 2) is within a range of 0.05-0.2 MPa.

7. The full recovery process of claim 1, wherein an oxygen volume content of the carbon-based gas in operation 2) is within a range of 15%-30%.

8. The full recovery process of claim 1, wherein 98%-99% of the volume of the carbon-based gas in operation 2) enters the bottom portion of the catalytic cracking regeneration device and 1%-2% of the volume of the carbon-based gas enters the upper portion of the catalytic cracking regeneration device.

9. The full recovery process of claim 1, wherein a regeneration temperature in the catalytic cracking regeneration device in operation 2) is controlled to be within a range of 650° C.-700° C.

10. The full recovery process of claim 1, wherein a concentration detecting device and a gas flow rate sensor are provided in the first connection pipe; a second temperature sensor and a second pressure sensor are provided in the catalytic cracking regeneration device; and
the process further includes:
obtaining a concentration sequence and a gas flow rate sequence in the first connection pipe, and a reaction parameter of the catalytic cracking regeneration device;
determining a combustion feature based on the concentration sequence and the gas flow rate sequence; and
in response to determining that the combustion feature satisfies a first preset condition, determining a target opening combination of a target flow rate regulating valve based at least on the combustion feature and the reaction parameter.

11. The full recovery process of claim 10, wherein to determine the target opening combination of the target flow rate regulating valve based at least on the combustion feature and the reaction parameter, the processor is further configured to:
generate at least one set of candidate parameters, wherein the at least one set of candidate parameters includes a candidate opening combination of the target flow rate regulating valve;
predict, through a prediction model, a predicted concentration sequence corresponding to the candidate opening combination, the prediction model being a machine learning model;
determine a predicted combustion feature based on the predicted concentration sequence; and
determine a target parameter based on the predicted combustion feature, wherein the target parameter includes the target opening combination corresponding to the target flow rate regulating valve.

12. The full recovery process of claim 11, wherein an input of the prediction model includes the combustion feature, the reaction parameter, the candidate opening combination, and at least one future time point; and
an output of the prediction model includes the predicted concentration sequence of the connection pipe at the at least one future time point under the candidate opening combination.

13. The full recovery process of claim 10, wherein the carbon-based gas mixer is detachably connected with the catalytic cracking regeneration device; and
the process further includes:
in response to determining that the combustion feature satisfies a second preset condition, determining a target size of the catalytic cracking regeneration device based on at least the combustion feature and the reaction parameter, wherein the target size of the catalytic cracking regeneration device includes a target ratio of an upper portion to a top portion of the catalytic cracking regeneration device.

14. The full recovery process of claim 13, wherein to determine the target size of the catalytic cracking regeneration device based on at least the combustion feature and the reaction parameter, the processor is further configured to:
generate at least one set of candidate parameters, wherein the at least one set of candidate parameters include a candidate ratio of the upper portion to the top portion of the catalytic cracking regeneration device;
predict, through a prediction model, a predicted concentration sequence corresponding to the candidate ratio, the prediction model being a machine learning model;
determine a predicted combustion feature based on the predicted concentration sequence; and
determine a target parameter based on the predicted combustion feature, wherein the target parameter includes the target ratio.
